(19) United States
(12) Patent Application Publication
(10) Pub. No.: US 2006/0063674 A1
(43) Pub. Date: Mar. 23, 2006

(54) Methods and apparatus for delivering time-release fertilizer

(76) Inventors: Robert Scott Morris JR., Wildwood, MO (US); Sanford Rush Simon, O'Fallon, MO (US)

Correspondence Address: Patrick W. Rasche;Armstrong Teasdale LLP, One Metropolitan Square, Suite 2600, St. Louis, MO, 63102, US

(21) Appl. No.: 10/948,626

(22) Filed: Sep. 23, 2004

(51) Int. Cl. A01N 59/04

(52) U.S. Cl. 504/101

(57) ABSTRACT

A fertilizer spike, in an exemplary embodiment, includes particulate fertilizer source material compacted together under pressure in a die to form a substantially wedged shaped spike body. The spike is configured to be hammered into a terrain such that the spike remains substantially intact. At least a portion of the fertilizer source materials are releasable into the terrain through microbial action. The fertilizer spike is substantially free of a thermoset binder material.

### BACKGROUND OF THE INVENTION

This invention relates generally to fertilizers, and more particularly to time-release fertilizer.

At least some known slow-release fertilizer spikes include a plurality of water-soluble particles, that may include some urea formaldehyde polymers, at least some of which may include fractions of water insoluble, sparingly soluble, and/or water-soluble polymers. The release of the fertilizer source materials, and more specifically, the timing of when the nutrients contained within the source materials are released from the spikes to the surroundings, is at least partially dependent on the porosity of such spikes. Known spikes include a plurality of fibrous particles, such as sawdust particles, in addition to the fertilizer source materials. Although such non-nutrient particulate matter facilitates increasing the porosity of known spikes, the fibrous particles also increase the frangibility of the spike such that the spikes may shatter if driven into compacted soil.

To facilitate enhancing the structural strength and the controlled release of the fertilizer source materials, at least some other known fertilizer spikes bind fertilizer source materials and fibrous materials together with a hardened material binder. The binder facilitates increasing the resistance of the spike to shattering. For example, at least some known spikes are bound together by a hardened material such as asbestos fibers and/or thermosetting resins. However, because spikes may require substantial amounts of binding material, the binding materials may inhibit the release of the fertilizer source materials from the spike, and thus decrease the effectiveness of the fertilizer spike. Moreover, the manufacturing costs of such spikes are generally increased in comparison to other known spikes due to the cost of the binder materials and/or the thermosetting process.

Other known fertilizer spikes require the use of tooling for insertion into compacted soil. For example, U.S. Pat. No. 3,892,552 describes a fertilizer spike that includes compressed granulated fertilizer particles bound together by an amount of urea-formaldehyde resin that is reduced in comparison to at least some other spikes that are bound by resins. Although the cured thermoset resin generally facilitates increasing the overall strength of the spike, the spike is described in a preferred embodiment as requiring a plastic cap to be placed on top of it, to facilitate reduced shattering when the spike is hammered into the ground.

### BRIEF DESCRIPTION OF THE INVENTION

In one aspect, a fertilizer spike that includes particulate fertilizer source material compacted together under pressure in a die to form a substantially wedged shaped spike body is provided. At least a portion of the fertilizer source material is releasable into the terrain through microbial action. The fertilizer source material includes about 1 to about 30 parts by weight diammonium phosphate, about 1 to about 30 parts by weight muriate of potash, about 1 to about 30 parts by weight of a material comprising 38 weight percent CH(NO₂)₃, about 1 to about 50 parts by weight of ammonium sulfate, and about 1 to about 20 parts by weight gypsum.

In another aspect, a fertilizer spike that includes particulate fertilizer source material compacted together under pressure in a die to form a substantially wedged shaped spike body is provided. The spike is formed without thermosetting the materials. At least a portion of the fertilizer source material is releasable into the terrain through microbial action, the fertilizer source materials are substantially free of a thermoset binder material.

In another aspect, a method for delivering a fertilizer to a plant over an extended period of time is provided. The method includes providing a fertilizer spike including particulate fertilizer source material compacted together under pressure in a die to form a substantially wedged shaped spike body, at least a portion of the fertilizer source material is releasable into the terrain through microbial action. The method also includes positioning an end of the spike against the terrain, and hammering directly against the opposite end of the spike such that the spike remains substantially intact and is forced into the terrain.

In a further aspect, a method for fabricating a fertilizer spike is provided. The method includes mixing a plurality of fertilizer source materials together, such that at least a portion of the fertilizer source materials is releasable into the terrain through microbial action. The fertilizer source materials are substantially free of a thermoset binder material. The method also includes injecting the mixture of fertilizer source materials into a spike-shaped die, using a tableting press to compress the mixture of fertilizer source materials into a wedge-shaped spike that has a structural strength that enables the spike to be hammered into a terrain such that said spike remains substantially intact.

In yet another aspect, a time-release fertilizer spike including a plurality of fertilizer source materials compacted together via a tableting process is provided. The spike includes a first end, a second end, and a body extending integrally therebetween. The body has a substantially rectangular cross-sectional profile. At least a portion of the fertilizer source materials are releasable into the terrain through microbial action. The fertilizer spike substantially free of a thermoset binder material.

### BRIEF DESCRIPTION OF THE DRAWINGS

FIG. 1 is a plan view of an exemplary time-release fertilizer spike;

FIG. 2 is a side view of the fertilizer spike shown in FIG. 1; and

FIG. 3 is a flowchart illustrating an exemplary method of fabricating a time-release fertilizer spike, such as the spike shown in FIG. 1.

### DETAILED DESCRIPTION OF THE INVENTION

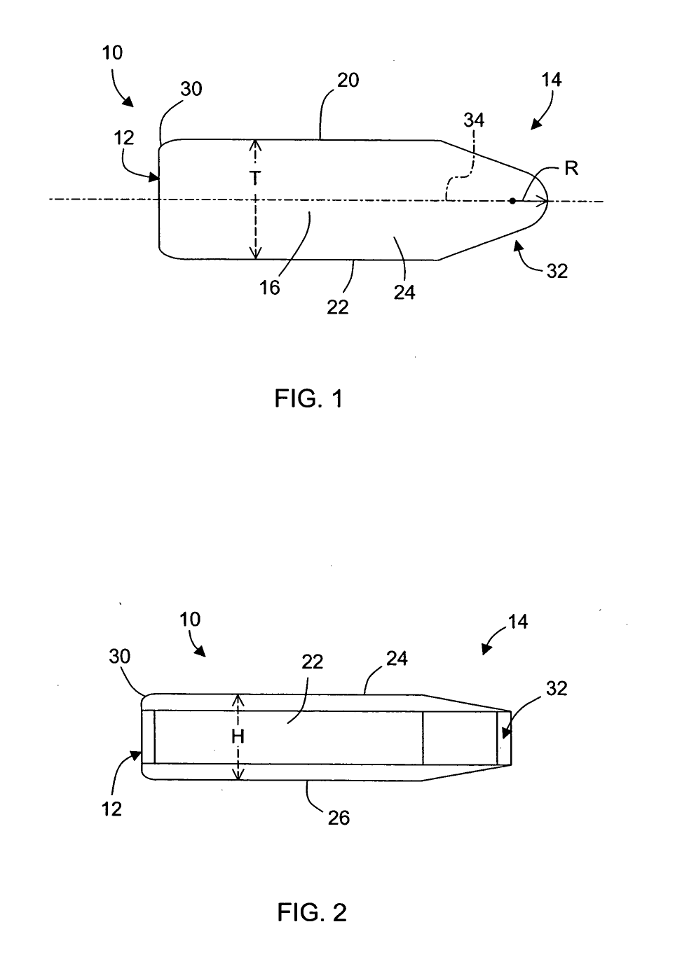

FIG. 1 is a plan view of an exemplary time-release fertilizer spike 10. FIG. 2 is a side view of fertilizer spike 10. Referring to FIGS. 1 and 2, spike 10 is a unitarily-formed, wedge-shaped spike that includes an impact end surface 12, an insertion end portion 14, and an elongated body 16 extending between end portion 14 and end surface 12. In the exemplary embodiment, body 16 has a substantially rectangular cross-sectional profile that is defined by a pair of identical opposing sidewall surfaces 20 and 22, and by an upper surface 24 and a lower surface 26 that extend between sidewall surfaces 20 and 22. In the exemplary embodiment, upper surface 24 is substantially parallel to, and identical to, lower surface 26. Moreover, in the exemplary embodiment, sidewall surfaces 20 and 22 are substantially parallel to each other, and each extends substantially perpendicularly between lower surface 26 and upper surface 24. In alternative embodiments, body 16 has a non-rectangular cross-sectional profile.

Body 16 has a thickness T measured between sidewall surfaces 20 and 22, and a height H measured between lower surface 26 and upper surface 24. In the exemplary embodiment, thickness T and height H are substantially constant throughout body 16. Accordingly, in the exemplary embodiment, sidewall surfaces 20 and 22, upper surface 24, and lower surface 26 are each generally planar.

Impact end surface 12 extends integrally from body 16 and has a substantially rectangular cross-sectional profile. Impact end surface is substantially planar and extends generally perpendicularly across body 16 with respect to sidewall surfaces 20 and 22, and with respect to upper surface 24 and lower surface 26. In the exemplary embodiment, a peripheral edge 30 of impact end surface 12 is formed with a radius of curvature to facilitate inadvertent shattering of spike 10 by a mis-directed blow while spike 10 is driven into the terrain during use.

Insertion end portion 14 extends integrally from body 16 and tapers to an insertion tip 32. More specifically, in the exemplary embodiment, the lower surface and upper surface 24 are substantially planar within insertion end portion 14, and sidewall surfaces 20 and 22 taper inwardly towards an axis of symmetry 34 extending through spike 10. In the exemplary embodiment, each surface 20 and 22 tapers approximately 24° inwardly to insertion tip 32. Tip 32 is formed with a radius of curvature that extends between sidewall surfaces 20 and 22. In the exemplary embodiment, tip 32 is substantially hemi-ellipsoidal shaped.

Alternatively, spike 10 may be formed to have any shape that, as described in more detail below, enables spike 10 to be hammered, unsupported, into the soil without shattering and such that spike 10 remains substantially undamaged while being driven into the ground. As used herein, the terms “undamaged” and/or “intact” means that the spike remains substantially unbroken when driven into the terrain, and may receive only minor splintering, cracking, dusting, powdering, and/or fracturing. In alternative embodiments, a plastic cap is inserted over impact end surface 12 prior to spike 10 being hammered into the soil. The plastic cap facilitates increasing the structural strength of spike 10 to further facilitate the spike remaining substantially undamaged while driven into the ground. As used herein, the term “hammered into the soil” means driving the fertilizer spike 10 into the soil by hitting spike 10 with a device, such as, but not limited to, a hammer, mallet, or similar device normally used to drive stakes, pegs, or similar objects. More specifically, spike 10 typically is fabricated to enable hammering directly against impact end surface 12 to force insertion end portion 14 into the soil.

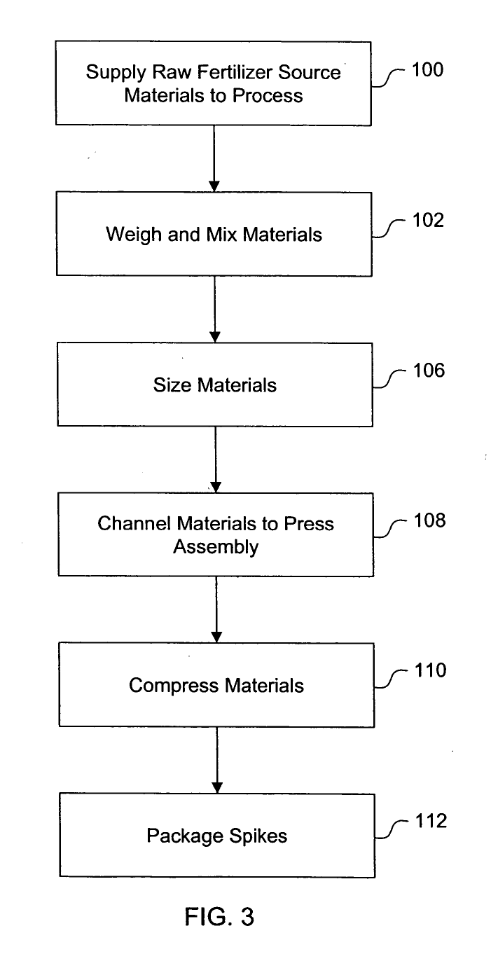

FIG. 3 is a flowchart illustrating an exemplary method of fabricating a time-release fertilizer spike, such as spike 10 shown in FIG. 1. In the exemplary embodiment, raw fertilizer source materials, as described in more detail below, are supplied 100 from a plurality of different containers. The fertilizer source materials are weighed and mixed 102 together such that a pre-determined amount of each source material is introduced to the mixture. In the exemplary embodiment, a conventional ribbon blender is used to mix 102 the materials together. Alternatively, other known means are used to mix 102 the materials together.

The resulting mixture is a substantially homogeneous granular mixture. As used herein, the term “homogeneous” means that the fertilizer source materials are mixed with substantially the same ratio of ingredients throughout spike 10. The blended mixture of fertilizer source materials is then sized 106 to ensure that generally only mixture particles of a pre-determined size limitation are used in the formation of the fertilizer spike. In the exemplary embodiment, a conventional roller mill is used to size the particles of the mixture. The sized particles are then channeled 108 to a press assembly to be formed into a fertilizer spike. In the exemplary embodiment, a conventional tablet press with uniquely-shaped die members, punches or molds is used to form the fertilizer spike. In one exemplary embodiment, a modified Stokes 210 Ton Tablet Press is used in forming the fertilizer spikes. In another exemplary embodiment, a modified Ballwin 45 Ton Tablet Press is used to form the fertilizer spikes. Pressure is applied to the dies to compress 110 the fertilizer source materials together such that the spike is bound together via the compression process. In an alternative embodiment, other compaction equipment such as, but not limited to, roll compaction presses or briquetting presses, is used rather than the tablet press, to form the fertilizer spike. More specifically, the mechanical bonding is sufficient to enable handling and/or packaging without awaiting a cure time, or without requiring heating/cooling cycles, thermosetting processes, thermoset resins, or adhesives. Accordingly, the fertilizer spikes are ejected from the dies and are packaged 112.

The spike is fabricated from a substantially homogenous granular mixture of fertilizer source materials which are comprised of water soluble, water insoluble, and sparingly soluble fertilizer sources. More specifically, the compaction of the fertilizer materials enables the nutrients to be gradually released due to reduced solubility from occlusion and through microbial activity into the surrounding soil solution for a continued delivery of nutrients which can be over a period of up to twelve months. As a result, nutrients are released from the fertilizer spike at a slower rate than with other known fertilizers, and fertilizer burn and nutrient loss through leaching is facilitated to be reduced in comparison to other known fertilizer spikes.

Generally, the fertilizer spike composition of any fertilizer source materials approved by the American Association of American Plant Food Control Officials, Inc. (AAPFCO). Moreover in one embodiment, the fertilizer spike composition includes nitrogen, phosphorus, and potassium source materials such as, but not limited to, magnesium ammonium phosphate or other metal ammonium phosphates, slag, ammonium metaphosphate, ammonium sulfate, Muritate of Potash, gypsum, calcium carbonate, dolomite, bone products, brucite, calcined phosphate, calcium metaphosphate, calcium phosphate, calcium polyphosphate, cement flue dust, chats, cottonseed extract, crotonylidene diurea, diamido phosphate, dicyandiamide, dolomite, fused calcium magnesium phosphate, fused tricalcium phosphate, fused phosphate, phosphate rock, gradually efficacious potassium phosphate, potassium silicate, guanylurea, greensand, magnesium oxide, magnesium phosphate, monocalcium diammonium pyrophosphate, methylene urea, ureaform, organiform, oxamidine phosphate, phosphatetraurea, phosphate sand, phosphoryltriamide, polyhalite, potassium polyphosphate, tankage, sludge, sulfate of potash magnesium, triuret, urea formaldehyde, uric acid, and/or sulfur. In addition, the fertilizer spike composition may also include calcium sulfate, sulfate of potash magnesia, potassium nitrate, Nutralene®, Nitroform®, monoammonium phosphate, and/or calcium nitrate.

The amounts of the components used in the fertilizer spike may vary based on the particular application of the spike and based on the plants desired to receive the nutrients from the spikes. However, generally the above fertilizer source materials are combined to provide a composition having pre-determined amounts of nitrogen, phosphorus, and potassium (NPK). The amounts of available nitrogen, phosphorus, and potassium are varied based on the requirements of the plants to be fertilized. However, the composition is typically selected to provide a spike that has a mechanical strength which enables it to be inserted into the terrain or compacted soil, without shattering, and such that the spike remains substantially undamaged while being driven into the soil.

In one embodiment, the fertilizer spike is formed with an NPK fertilizer weight percentage of 12-5-7, et al, i.e., 12 parts nitrogen to 5 parts phosphorus to 7 parts potassium. Other nutrient ratios may be varied according to specific plant requirements. More specifically, in such an embodiment, the fertilizer spike is formed with a fertilizer composition which contains about 9.0 parts Diammonium Phosphate, DAP 18-46-0, about 13.75 parts Muriate of Potash, MOP 0-0-60, 12.65 parts Nitroform® 38-0-0 (CH(NO2)₃), about 46.25 parts Ammonium Sulfate 21-0-0, and about 18.35 parts granular gypsum, where the parts are parts by weight. In alternate embodiments, the fertilizer spike contains from about 1 to about 30 parts of diammonium phosphate, from about 1 to about 30 parts of muriate of potash, from about 1 to about 30 parts of Nitroform® 38-0-0 (CH(NO2)₃), from about 1 to about 50 parts of ammonium sulfate, and from about 1 to about 20 parts gypsum, where the parts are parts by weight.

In an alternative embodiment, the spike may also include an active component which has a particular desired effect on plant growth or health when released to the plant over an extended period of time. For example, such desired effects may include, but are not limited to, control of pests or diseases, such as would be available from a pesticide. As used herein, the term “pesticide” includes any substance or mixture of substances, including fungicides, intended for preventing, destroying, repelling, or mitigating any insect, rodents, nematodes, fungi, or weeds, or any other forms of life declared to be pests, and any substance or mixture of substances intended for use as a plant growth regulator, rooting hormone, defoliant, or desiccant. Moreover, the term pesticide includes, but is not limited to including, systemic and non-systemic herbicides, algaecides, fungicides, insecticidal toxicants, nitrification inhibitors, acaricides, and nematocides.

The above-described fertilizer spike provides a cost-effective and reliable means for delivering nutrients to a plant over an extended period of time. More specifically, the wedge-shaped fertilizer spike is fabricated through a tableting process that produces a spike having a shape and a mechanical strength that enables the spike to be hammered into the soil without shattering, such that the spike remains substantially undamaged while being driven into the ground. In other embodiments, a cap is inserted over the spike to facilitate increasing the structural strength of the spike and to further facilitate the spike remaining substantially undamaged while driven into the ground. Furthermore, following fabrication through the tableting process, the mechanical bonding properties of the spike enable the spike to be immediately handled and/or packaged following ejection from the tablet press dies. Accordingly, manufacturing costs are reduced in comparison to other known spikes because no cure times or heating/cooling cycles are required. Moreover, manufacturing costs are also reduced because the fertilizer spike is fabricated without thermoset materials or adhesives. As a result, a fertilizer spike is provided which facilitates the delivery of nutrients through hydrolysis and microbial activity in a cost-effective and reliable manner.

An exemplary embodiment of a fertilizer spike and an associated method of fabrication are described above in detail. The fertilizer spike illustrated is not limited to the specific embodiments described herein, but rather, as will be appreciated by one skilled in the art, other embodiments of fertilizer spikes and other methods of fabrication are available.

While the invention has been described in terms of various specific embodiments, those skilled in the art will recognize that the invention can be practiced with modification within the spirit and scope of the claims.

What is claimed is:

1. A fertilizer spike comprising particulate fertilizer source material compacted together under pressure in a die to form a substantially wedged shaped spike body, at least a portion of said fertilizer source material is releasable into the terrain through microbial action, said fertilizer source material comprising:
about 1 to about 30 parts by weight diammonium phosphate;
about 1 to about 30 parts by weight muriate of potash;
about 1 to about 30 parts by weight of a ureaform material comprising 38 weight percent CH(NO₂)₃;
about 1 to about 50 parts by weight of ammonium sulfate; and
about 1 to about 20 parts by weight gypsum.

2. A fertilizer spike in accordance with claim 1 wherein said fertilizer source materials further comprise a pesticidal component.

3. A fertilizer spike in accordance with claim 1 wherein a portion of said fertilizer source materials are substantially water-insoluble, said spike configured to be hammered while unsupported into a terrain such that said spike remains substantially intact.

4. A fertilizer spike in accordance with claim 1 wherein said fertilizer source materials are configured to facilitate reducing leaching within the terrain.

5. A fertilizer spike in accordance with claim 1 wherein said spike comprises a first end having a substantially rectangular cross-sectional profile, and an opposite second end having a substantially hemi-ellipsoidal shape.

6. A fertilizer spike in accordance with claim 1 wherein said spike is formed without thermosetting.

7. A fertilizer spike comprising particulate fertilizer source material compacted together under pressure in a die to form a substantially wedged shaped spike body, said spike is formed without thermosetting, at least a portion of said fertilizer source material is releasable into the terrain through microbial action, said fertilizer source materials substantially free of a thermoset binder material.

8. A fertilizer spike in accordance with claim 7 wherein said fertilizer material comprises:
about 1 to about 30 parts by weight diammonium phosphate;
about 1 to about 30 parts by weight muriate of potash;
about 1 to about 30 parts by weight of a ureaform material comprising 38 weight percent CH(NO₂)₃;
about 1 to about 50 parts by weight of ammonium sulfate; and
about 1 to about 20 parts by weight gypsum.

9. A fertilizer spike in accordance with claim 7 wherein said fertilizer source materials further comprise a pesticidal component.

10. A fertilizer spike in accordance with claim 7 wherein a portion of said fertilizer source materials are substantially water-insoluble.

11. A fertilizer spike in accordance with claim 7 wherein said fertilizer source materials are configured to facilitate reducing leaching within the terrain.

12. A fertilizer spike in accordance with claim 7 wherein said spike comprises a first end having a substantially rectangular cross-sectional profile, and an opposite second end having a substantially hemi-ellipsoidal shape.

13. A method for delivering fertilizer to a plant over an extended period of time, said method comprising:
providing a fertilizer spike comprising particulate fertilizer source material compacted together under pressure in a die to form a substantially wedged shaped spike body, at least a portion of the fertilizer source material is releasable into the terrain through microbial action, the fertilizer source materials substantially free of a thermoset binder material;
positioning an end of the spike against the terrain; and
hammering directly against the opposite end of the spike such that the spike remains substantially intact and is forced into the terrain.

14. A method in accordance with claim 13 wherein hammering directly against the opposite end of the spike further comprises positioning the spike with respect to the plant such that a time-release fertilizer component included within the compacted fertilizer source materials is released into the terrain through microbial action.

15. A method in accordance with claim 13 further comprising positioning the spike with respect to the plant such that a pesticidal component included within the compacted fertilizer source materials is released into the terrain.

17. A method in accordance with claim 13 wherein hammering directly against the opposite end of the spike further comprises hammering directly against the end of the spike having a substantially rectangular cross-sectional profile.

18. A method in accordance with claim 13 wherein positioning an end of the spike against the terrain further comprises positioning an end of the spike having a substantially hemi-ellipsoidal shape against the terrain.

19. A method for fabricating a fertilizer spike, said method comprising:
mixing a plurality of fertilizer source materials together, such that at least a portion of the fertilizer source materials is releasable into the terrain through microbial action, the fertilizer source materials substantially free of a thermoset binder material;
injecting the mixture of fertilizer source materials into a spike-shaped die; and
using compaction equipment to compress the mixture of fertilizer source materials into a wedge-shaped spike that has a structural strength that enables the spike to be hammered into a terrain such that said spike remains substantially intact.

20. A method in accordance with claim 19 wherein mixing a plurality of fertilizer source materials together further comprises mixing a plurality of fertilizer source materials together including a time-release fertilizer component that is releasable into a terrain through microbial action.

21. A method in accordance with claim 19 further comprising:
weighing each fertilizer source material used in the mixture to ensure that a pre-determined amount of each source material is mixed together; and
sizing the particles of each source material to limit the size of the particles within the mixture.

22. A method in accordance with claim 19 wherein mixing a plurality of fertilizer source materials together further comprises mixing a plurality of fertilizer source materials together including a pesticidal component.

22. A method in accordance with claim 19 wherein using a tableting press to compress the mixture of fertilizer source materials into a wedge-shaped spike further comprises forming one end of the spike with a substantially rectangular cross-sectional profile, and forming an opposite end of the spike with a substantially hemi-ellipsoidal cross-sectional profile.

23. A method in accordance with claim 19 wherein using a tableting press to compress the mixture of fertilizer source materials into a wedge-shaped spike further comprises forming the fertilizer spike without using a thermosetting process.

24. A time-release fertilizer spike comprising a plurality of fertilizer source materials compacted together via a tableting process, said spike comprising a first end, a second end, and a body extending integrally therebetween, said body has a substantially rectangular cross-sectional profile, at least a portion of said fertilizer source materials are releasable into the terrain through microbial action, said fertilizer spike substantially free of a thermoset binder material.

25. A spike in accordance with claim 24 wherein a width of said body is substantially constant throughout said body.

26. A spike in accordance with claim 25 wherein a thickness of said body is substantially constant throughout said body.

27. A spike in accordance with claim 24 wherein said first end has a substantially rectangular cross-sectional profile, said second end has a substantially hemi-ellipsoidal cross-sectional profile.

28. A spike in accordance with claim 24 wherein said plurality of source materials comprise a time-release fertilizer component that is released into the terrain through microbial action.

29. A spike in accordance with claim 24 wherein said plurality of source materials comprise a pesticidal component.

30. A spike in accordance with claim 24 wherein at least a portion of said plurality of source materials are water-insoluble.

31. A spike in accordance with claim 24 wherein said spike is configured to be hammered while unsupported into a terrain such that said spike remains substantially intact.

32. A spike in accordance with claim 24 wherein said spike is substantially shatter resistant.
